(19) United States
(12) Patent Application Publication
(10) Pub. No.: US 2026/0067521 A1
(43) Pub. Date: Mar. 5, 2026

(54) AUDIO CALIBRATION USING TELEVISION REMOTE

(71) Applicant: Sonos, Inc., Goleta, CA (US)

(72) Inventors: Jerad Lewis, Cambridge, MA (US); Jonathan Cole Harris, Santa Barbara, CA (US)

(21) Appl. No.: 19/313,157

(22) Filed: Aug. 28, 2025

Related U.S. Application Data
(60) Provisional application No. 63/688,568, filed on Aug. 29, 2024.

(51) Int. Cl. H04N 21/422; H04N 21/488

(52) U.S. Cl. CPC H04N 21/42203; H04N 21/4882

(57) ABSTRACT

Example technologies described herein relate to calibration of playback devices using a remote control (such as for a television or streaming video set-top box or stick). Any environment has certain acoustic characteristics (“acoustics”) that define how sound travels within that environment. Example calibration processes for a playback device may involve the playback device outputting audio content while in a given environment (e.g., a room). Then, one or more microphones in the remote control detect the played back audio content to facilitate determining an acoustic response of the room (also referred to herein as a “room response”). Calibration settings for the playback device are then determined that, when applied to future playback by the playback device, at least partially offset the acoustic characteristics of the environment so as to reduce or eliminate the effect of the environment on output of the playback device.

### CROSS-REFERENCE TO RELATED APPLICATION

This application claims the benefit of priority to U.S. patent application Ser. No. 63/688,568, filed Aug. 29, 2024, which is incorporated herein by reference in its entirety.

### FIELD OF THE DISCLOSURE

The present technology relates to consumer goods and, more particularly, to methods, systems, products, features, services, and other elements directed to voice-assisted control of media playback systems or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings where:

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the playback device of FIG. 2A.

FIG. 2C is a diagram of an example voice input.

FIG. 2D is a graph depicting an example sound specimen in accordance with aspects of the disclosure.

FIGS. 3A, 3B, 3C, 3D and 3E are diagrams showing example playback device configurations in accordance with aspects of the disclosure.

FIG. 4 is a functional block diagram of an example controller device in accordance with aspects of the disclosure.

FIGS. 5A and 5B are controller interfaces in accordance with aspects of the disclosure.

FIG. 6 is a message flow diagram of a media playback system.

FIG. 7 is a functional block diagram of an example streamer device in accordance with aspects of the disclosure.

FIG. 8 is a functional block diagram of an example remote control in accordance with aspects of the disclosure.

FIGS. 9A, 9B, 9C and 9D are diagrams illustrating example calibration technologies in accordance with aspects of the disclosure.

FIG. 10 is a flow diagram of an example method to calibrate playback devices in accordance with aspects of the disclosed technology.

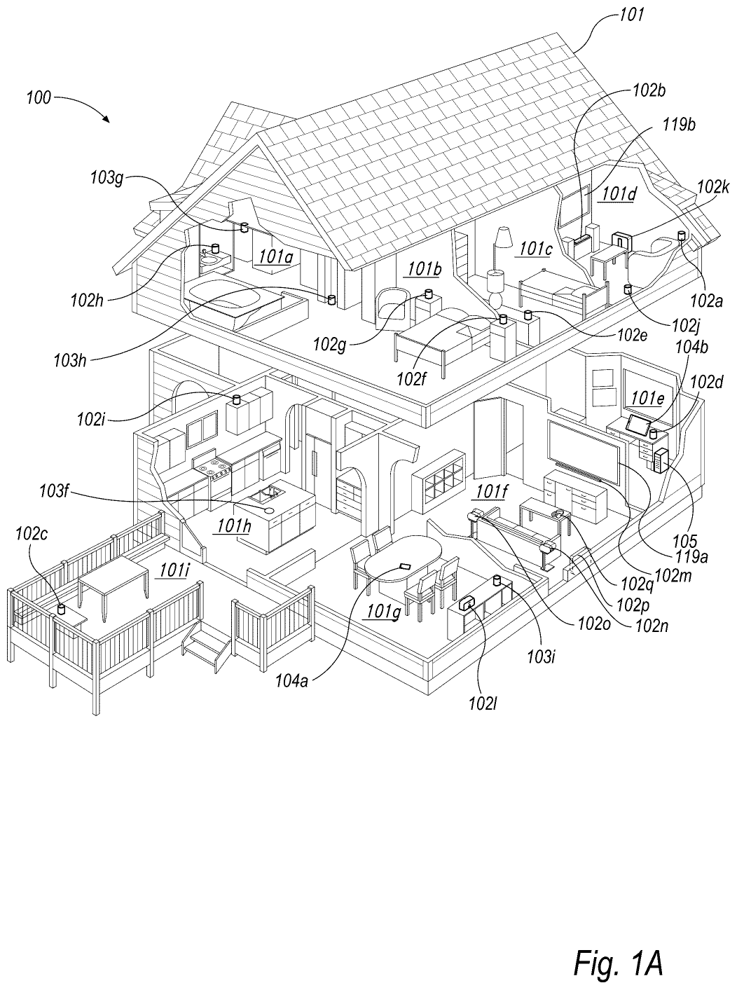

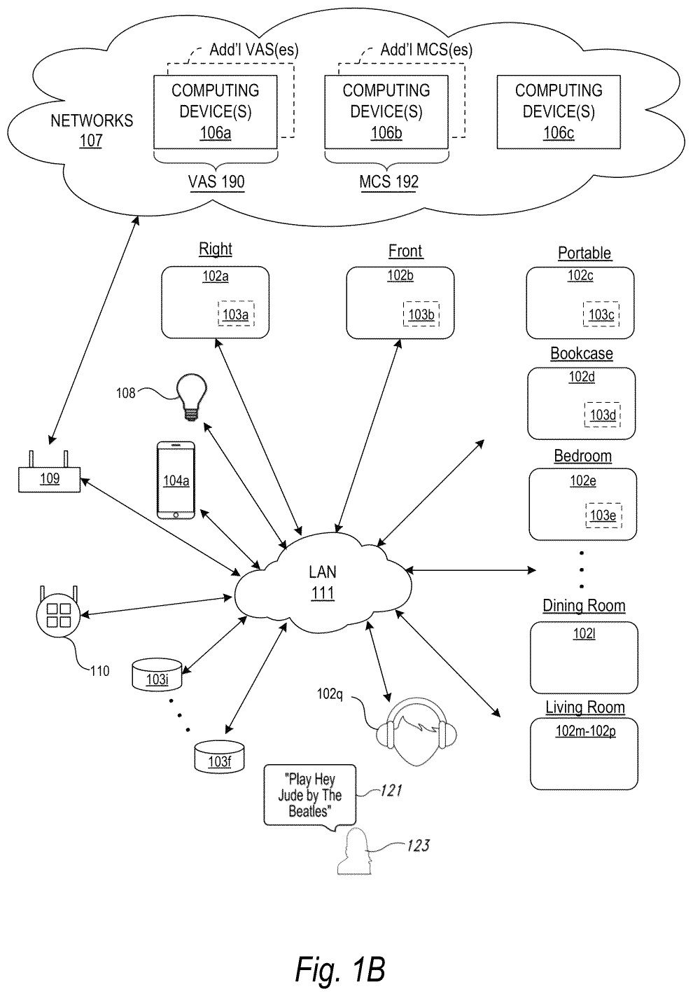

The drawings are for purposes of illustrating example embodiments, but it should be understood that the inventions are not limited to the arrangements and instrumentality shown in the drawings. In the drawings, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### DETAILED DESCRIPTION

### I. Overview

Example technologies described herein relate to calibration of playback devices using a remote control (such as for a television or streaming video set-top box or stick). Any environment has certain acoustic characteristics (“acoustics”) that define how sound travels within that environment. Calibration of playback devices may at least partially offset the acoustics of the environment, so as to achieve more consistent audio playback in various listening environments.

When the environment is a room, the size and shape of the room, as well as objects inside that room, define the acoustics for that room. For example, angles of walls with respect to a ceiling affect how sound reflects off the wall and the ceiling. As another example, furniture positioning in the room affects how the sound travels in the room. Various types of surfaces within the room may also affect the acoustics of that room; hard surfaces in the room tend to reflect sound, whereas soft surfaces tend to absorb sound.

Example calibration processes for a playback device may involve the playback device outputting audio content while in a given environment (e.g., a room). Then, one or more microphones detect the played back audio content to facilitate determining an acoustic response of the room (also referred to herein as a “room response”). Calibration settings for the playback device are then determined that, when applied to future playback by the playback device, at least partially offset the acoustic characteristics of the environment so as to reduce or eliminate the effect of the environment on output of the playback device.

In some examples, the microphones used to detect output of the playback device are located in a mobile device and the microphones detect output of the playback device at one or more different spatial positions in the room. In particular, a mobile device with a microphone, such as a smartphone or tablet (referred to herein as a network device) may be moved to the various locations in the room to detect the audio content. These locations may correspond to those locations where one or more listeners may experience audio playback during regular use (i.e., listening to) of the playback device.

In this regard, the calibration process involves a user physically moving the network device to various locations in the room to detect the audio content at one or more spatial positions in the room. Given that this calibration involves moving the microphone to multiple locations throughout the room, this calibration may also be referred to as a “multi-location calibration” and it may generate a “multi-location acoustic response” representing room acoustics. U.S. Pat. No. 9,706,323 entitled, “Playback Device Calibration,” U.S. Pat. No. 9,763,018 entitled, “Calibration of Audio Playback Devices,”, and U.S. Pat. No. 10,299,061, entitled, “Playback Device Calibration,” which are hereby incorporated by reference in their entirety, provide examples of multi-location calibration of playback devices to account for the acoustics of a room.

One possible issue with using microphones in a mobile device in a calibration is the ever changing and wide selection of smartphones and tablet devices available on the market. Given this selection, users of a playback device that desire to calibrate their playback device can be expected to have different mobile devices with various microphones. The different microphones in these mobile devices may vary in their sensitivity to audio stimulus across different frequencies (i.e., in their microphone response), which impacts calibration if not accounted for or otherwise offset in the determination of the calibration settings.

Some media playback systems may include a streaming video set-top box or stick, referred to herein as a “streaming device. ” Similar to other commercially-available streamers, such a streaming device is configured to stream media from various sources (e.g., streaming audio/video services) and output A/V signals to a television or other display. Some televisions have streaming device functionality built-in, and thus can be considered to include a streaming device.

Within examples, the streaming device is controllable via a remote control. The remote control may include various buttons or other selectable controls to access various functions of the streaming device, such as playback control, volume control, and menu navigation. The remote control may also include one or more microphones, which may be used for voice control of the streaming device.

The microphones of the remote control may also be used to capture audio for calibration of the audio playback devices. Relative to the varied mobile devices that users may purchase for themselves, the microphones in the remote control may be expected to be relatively more consistent, as a certain microphone or microphones may be selected and manufactured to a particular specification. Given this consistency, the microphone(s) in the remote control can be more accurately modeled and their characteristics more consistently and/or accurately accounted for in the calibration process as compared with the wide variety of microphones used in commercially available mobile devices.

In other examples, the microphone(s) and/or other hardware implemented in the remote control may be relatively less capable compared with microphones and other hardware implemented in a mobile device. For instance, the microphones implemented in the remote control might be of a lesser sensitivity. As another example, the signal path (e.g., via Bluetooth®) to send captured audio from the remote control back to the media playback system (e.g., to the streaming device) for processing might not support as high of sample rate or dynamic range relative to that of a mobile device. As another example, the codec used by the remote to encode recordings for voice control might not as accurately represent the calibration audio (e.g., because the codec encodes for perceptual accuracy to support voice control). The reasons for these hardware differences may vary, but some considerations are the relative market pricing expectations of a streaming device (and its accompanying remote control) compared with a mobile device as well as the dual-use nature of the microphones (i.e., for voice control and calibration).

In such examples, the calibration process when using the remote control to calibrate may be modified, adapted, or re-designed relative to the calibration process when using a mobile device. For instance, a remote control based calibration process may capture audio over a smaller bandwidth, or capture less data, relative to a mobile device based calibration process. Other adjustments are possible as well.

For instance, the relatively smaller dataset may be used to identify calibration settings that make adjustments over a larger frequency range. For instance, the captured data set may be mapped to an estimated room response with a transfer function that has that has been derived from a dataset of previously captured room responses. U.S. Pub. No. 2023/0362570 A1 entitled, “Playback Device Self-Calibration Using PCA-Based Room Response Estimation,” which is hereby incorporated by reference in its entirety, provide examples of such technologies.

As noted above, example technologies relate to calibration of playback devices using a remote control. An example includes during a first portion of a calibration, capturing, via a microphone of a remote control, first audio played back by one or more playback devices while the remote control is in motion through an environment that includes the one or more playback devices; during a second portion of the calibration, capturing, via the microphone of the remote control, second audio played back by the one or more playback devices while the remote control is in stationary in the environment at a listening location; determining calibration settings that, when applied to playback by the one or more playback devices, at least partially (i) offset acoustic characteristics of the environment that were represented in the captured first audio and (ii) offset differences in relative positioning between the multiple transducers and the listening location; and causing, via the network interface, the one or more playback devices to apply the determined calibration settings.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

Moreover, some functions are described herein as being performed “based on” or “in response to” another element or function. “Based on” should be understood that one element or function is related to another function or element. “In response to” should be understood that one element or function is a necessary result of another function or element. For the sake of brevity, functions are generally described as being based on another function when a functional link exists; however, such disclosure should be understood as disclosing either type of functional relationship.

### II. Example Operation Environment

FIGS. 1A and 1B illustrate an example configuration of a media playback system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b, (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102q), network microphone devices 103 (identified individually as “NMDs” 103a-102i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A).

Yet further, the one or more of the computing devices may be connected to a display device, such as a television. For instance, one or more playback devices 102 may be connected via a suitable interface (e.g., HDMI audio return channel (ARC)) such that when video is presented on the display device, the playback device(s) 102 play back the accompanying audio. To illustrate, as shown in FIG. 1A, the playback device 102m in the living room 101f is connected to a television 119a and the playback device 102b in the den 101d is connected to a television 119b. The television 119a and the television 119b are representative of various types of display devices, such as televisions, computer monitors, projectors, and the like. The television 119a and the television 119b can be referred to collectively as the televisions 119.

In embodiments described below, one or more of the various playback devices 102 may be configured as portable playback devices, while others may be configured as stationary playback devices. For example, the headphones 102q (FIG. 1B) are a portable playback device, while the playback device 102d on the bookcase may be a stationary device. As another example, the playback device 102c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices 102, 103, and 104 and/or other network devices of the MPS 100 may be coupled to one another via point-to-point connections and/or over other connections, which may be wired and/or wireless, via a network 111, such as a LAN including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related embodiment, the Left playback device 102j may communicate with other network devices, such as the playback device 102b, which may be designated as the “Front” device, via a point-to-point connection and/or other connections via the NETWORK 111.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a VAS and at least one remote computing device associated with a media content service (“MCS”). For instance, in the illustrated example of FIG. 1B, remote computing devices 106 are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the playback devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 102l, 102m, and 102n, which are named “Bedroom,” “Dining Room,” “Living Room,” and “Office,” respectively. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the network 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Application No. Ser. No. 15/438,749 filed Feb. 21, 2017, and titled “Voice Control of a Media Playback System,”which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. Application No. Ser. No. 15/438,749.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 102l, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Application No.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the NETWORK 111 (FIG. 1B) may be eliminated and the single playback device 102 and/or the single NMD 103 may communicate directly with the remote computing devices 106a-c. In some embodiments, a telecommunication network (e.g., an LTE network, a 5G network, etc.) may communicate with the various playback, network microphone, and/or controller devices 102-104 independent of a LAN.

a. Example Playback & Network Microphone Devices

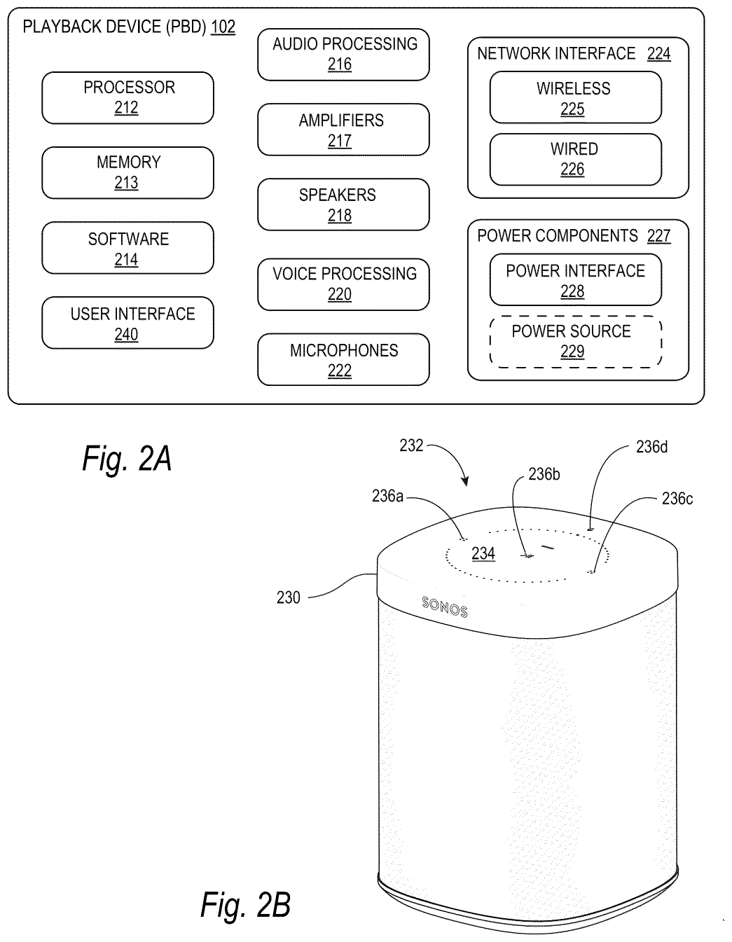

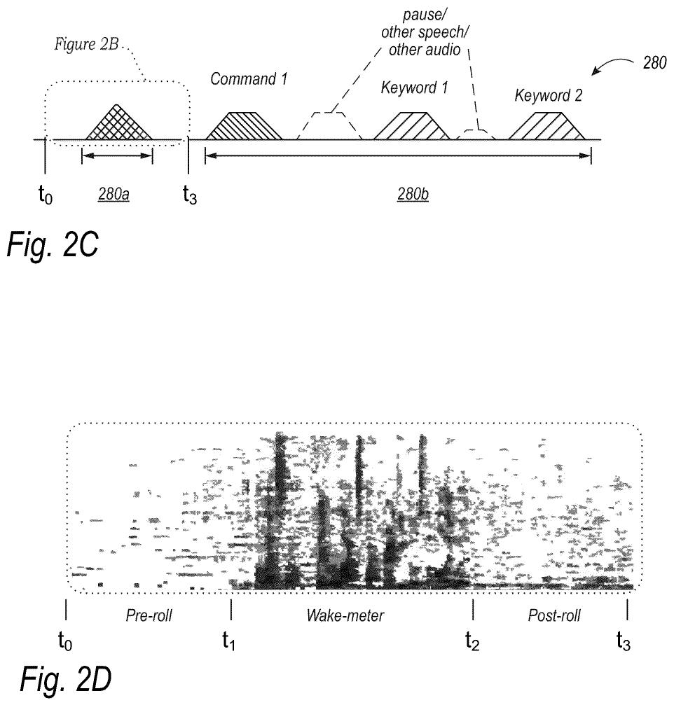

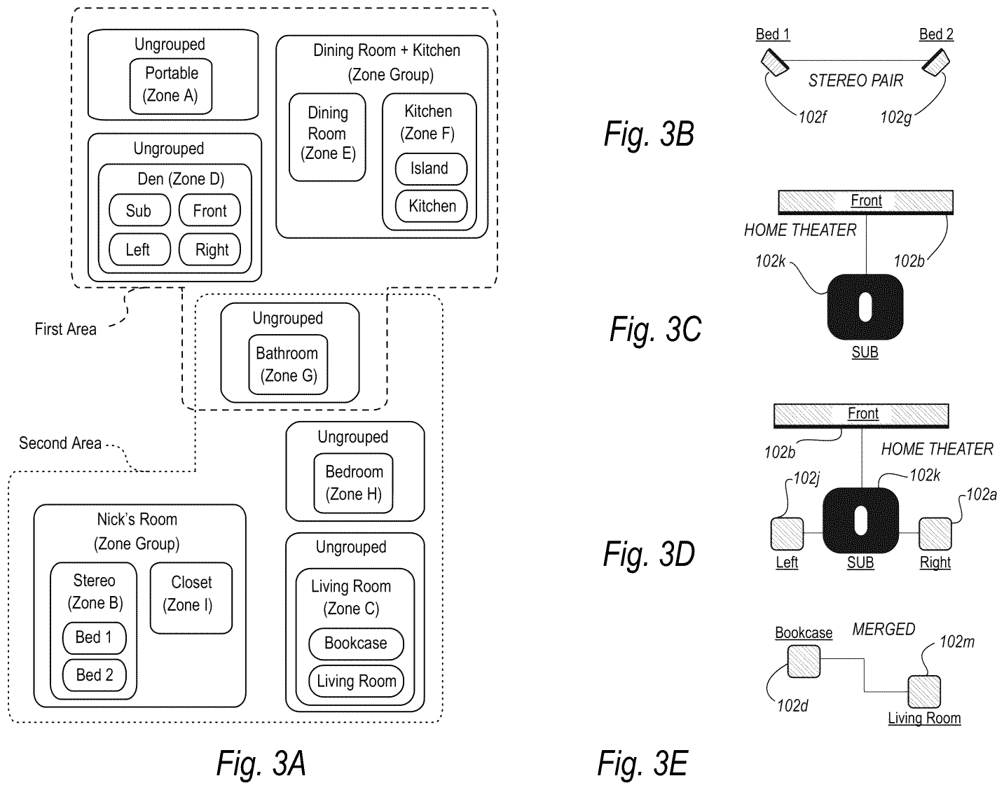

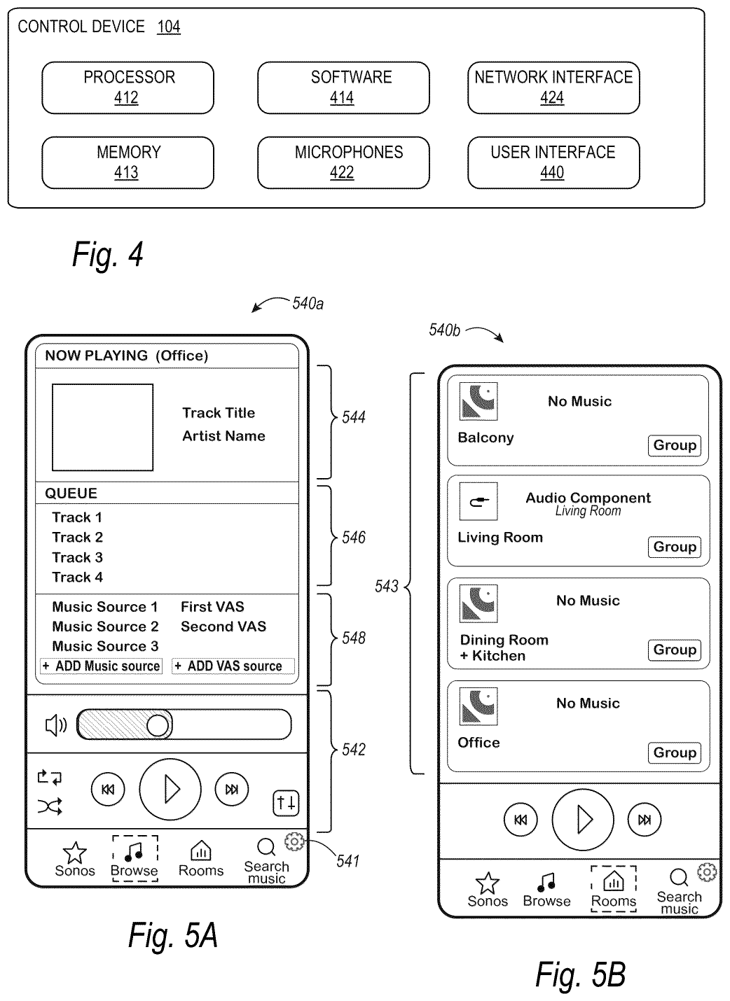

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the playback device to external speakers. In certain embodiments, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A include both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the playback device 102.

By way of illustration, SONOS, Inc. presently offers (or has offered) for sale certain playback devices that may implement certain of the embodiments disclosed herein, including a “PLAY: 1,” “PLAY: 3,” “PLAY: 5,” “PLAYBAR,” “CONNECT: AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIG. 2A or 2B or to the SONOS product offerings. For example, a playback device may include, or otherwise take the form of, a wired or wireless headphone set, which may operate as a part of the MPS 100 via a network interface or the like. In another example, a playback device may include or interact with a docking station for personal mobile media playback devices. In yet another example, a playback device may be integral to another device or component such as a television, a lighting fixture, or some other device for indoor or outdoor use.

FIG. 2C is a diagram of an example voice input 280 that may be processed by an NMD or an NMD-equipped playback device. The voice input 280 may include a keyword portion 280a and an utterance portion 280b. The keyword portion 280a may include a wake word or a local keyword.

In the case of a wake word, the keyword portion 280a corresponds to detected sound that caused a VAS wake-word event. In practice, a wake word is typically a predetermined nonce word or phrase used to “wake up” an NMD and cause it to invoke a particular voice assistant service (“VAS”) to interpret the intent of voice input in detected sound. For example, a user might speak the wake word “Alexa” to invoke the AMAZON® VAS, “Ok, Google” to invoke the GOOGLE® VAS, or “Hey, Siri” to invoke the APPLE® VAS, among other examples. In practice, a wake word may also be referred to as, for example, an activation-, trigger-, wakeup-word or-phrase, and may take the form of any suitable word, combination of words (e.g., a particular phrase), and/or some other audio cue.

The utterance portion 280b corresponds to detected sound that potentially comprises a user request following the keyword portion 280a. An utterance portion 280b can be processed to identify the presence of any words in detected-sound data by the NMD in response to the event caused by the keyword portion 280a. In various implementations, an underlying intent can be determined based on the words in the utterance portion 280b. In certain implementations, an underlying intent can also be based or at least partially based on certain words in the keyword portion 280a, such as when keyword portion includes a command keyword. In any case, the words may correspond to one or more commands, as well as a certain command and certain keywords.

A keyword in the voice utterance portion 280b may be, for example, a word identifying a particular device or group in the MPS 100. For instance, in the illustrated example, the keywords in the voice utterance portion 280b may be one or more words identifying one or more zones in which the music is to be played, such as the Living Room and the Dining Room (FIG. 1A). In some cases, the utterance portion 280b may include additional information, such as detected pauses (e.g., periods of non-speech) between words spoken by a user, as shown in FIG. 2C. The pauses may demarcate the locations of separate commands, keywords, or other information spoke by the user within the utterance portion 280b.

Based on certain command criteria, the NMD and/or a remote VAS may take actions as a result of identifying one or more commands in the voice input. Command criteria may be based on the inclusion of certain keywords within the voice input, among other possibilities. Additionally, state and/or zone-state variables in conjunction with identification of one or more particular commands. Control-state variables may include, for example, indicators identifying a level of volume, a queue associated with one or more devices, and playback state, such as whether devices are playing a queue, paused, etc. Zone-state variables may include, for example, indicators identifying which, if any, zone players are grouped.

In some implementations, the MPS 100 is configured to temporarily reduce the volume of audio content that it is playing upon detecting a certain keyword, such as a wake word, in the keyword portion 280a. The MPS 100 may restore the volume after processing the voice input 280. Such a process can be referred to as ducking, examples of which are disclosed in U.S. patent application Ser. No. 15/438,749, incorporated by reference herein in its entirety.

FIG. 2D shows an example sound specimen. In this example, the sound specimen corresponds to the sound-data stream (e.g., one or more audio frames) associated with a spotted wake word or command keyword in the keyword portion 280a of FIG. 2A. As illustrated, the example sound specimen comprises sound detected in an NMD's environment (i) immediately before a wake or command word was spoken, which may be referred to as a pre-roll portion (between times t0 and t1), (ii) while a wake or command word was spoken, which may be referred to as a wake-meter portion (between times t1 and t2), and/or (iii) after the wake or command word was spoken, which may be referred to as a post-roll portion (between times t2 and t3). Other sound specimens are also possible. In various implementations, aspects of the sound specimen can be evaluated according to an acoustic model which aims to map mels/spectral features to phonemes in a given language model for further processing. For example, automatic speech recognition (ASR) may include such mapping for command-keyword detection. Wake-word detection engines, by contrast, may be precisely tuned to identify a specific wake-word, and a downstream action of invoking a VAS (e.g., by targeting only nonce words in the voice input processed by the playback device).

ASR for local keyword detection may be tuned to accommodate a wide range of keywords (e.g., 5, 10, 100, 1,000, 10,000 keywords). Local keyword detection, in contrast to wake-word detection, may involve feeding ASR output to an onboard, local NLU which together with the ASR determine when local keyword events have occurred. In some implementations described below, the local NLU may determine an intent based on one or more keywords in the ASR output produced by a particular voice input. In these or other implementations, a playback device may act on a detected command keyword event only when the playback devices determines that certain conditions have been met, such as environmental conditions (e.g., low background noise).

b. Example Playback Device Configurations

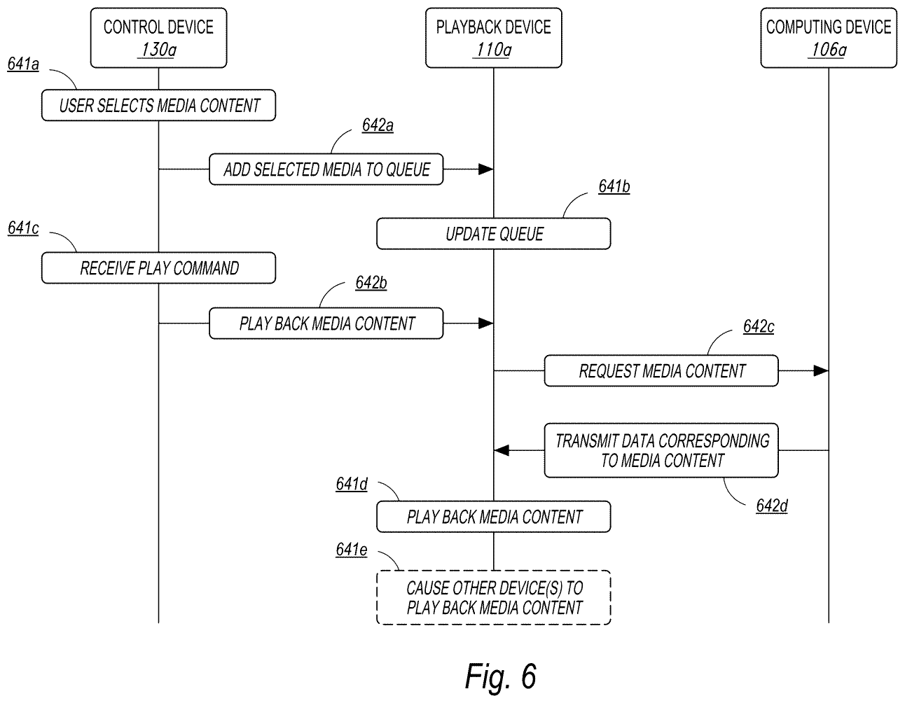

FIG. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1″ in FIG. 3A may be bonded to the playback device 102g (FIG. 1A) named ”Bed 2″ in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various embodiments, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In further examples, one or more playback devices 102 in a single bonded room or zone may include upward-firing transducers to facilitate playback of spatial audio such as Dolby Atmos®. For instance, the playback device 102b may include upward firing drivers configured to render overhead sound when playing spatial audio. As another example, referring back to FIG. 1A, the playback device 102n and the playback device 102o may include side-firing transducers to form surround channels and also upward-firing transducers to form overhead channels when playing spatial audio.

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the playback devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in previously referenced U.S. patent application Ser. No. 15/438,749. In some embodiments, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I.

The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room +Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the MPS 100, which may be shared from time to time among the devices so that one or more of the devices have the most recent data associated with the system.

In some embodiments, the memory 213 of the playback device 102 may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room +Kitchen group and that devices 103f and 102i are bonded. Identifiers associated with the Kitchen may indicate the same or similar information by virtue of the Kitchen being part of the Dining Room +Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. Application No. Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In embodiments described below, the memory 213 is configured to store a set of command data for selecting a particular VAS when processing voice inputs. During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone.

For instance, the user may be in the Office zone where the playback device 102n is playing the same hip-hop music that is being playing by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room 101g and the Kitchen 101h may be combined into a zone group for a dinner party such that playback devices 102i and 102l may render audio content in synchrony. As another example, bonded playback devices in the Den 101d may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space.

In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

c. Example Controller Devices

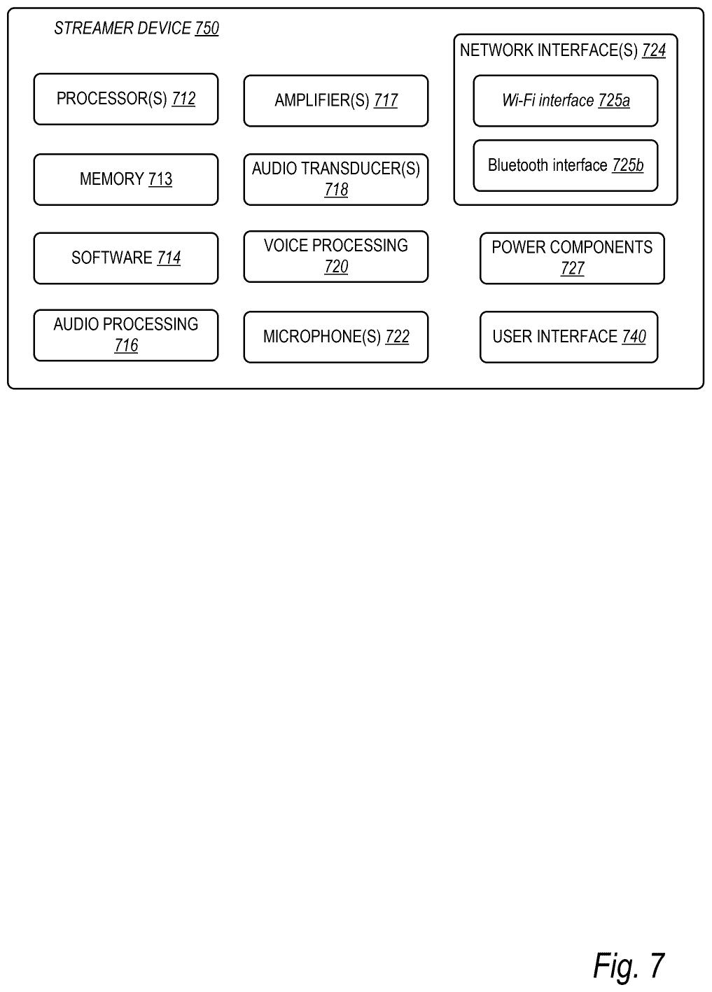

FIG. 4 is a functional block diagram illustrating certain aspects of a selected one of the controller devices 104 of the MPS 100 of FIG. 1A. Such controller devices may also be referred to herein as a “control device” or “controller.” The controller device shown in FIG. 4 may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

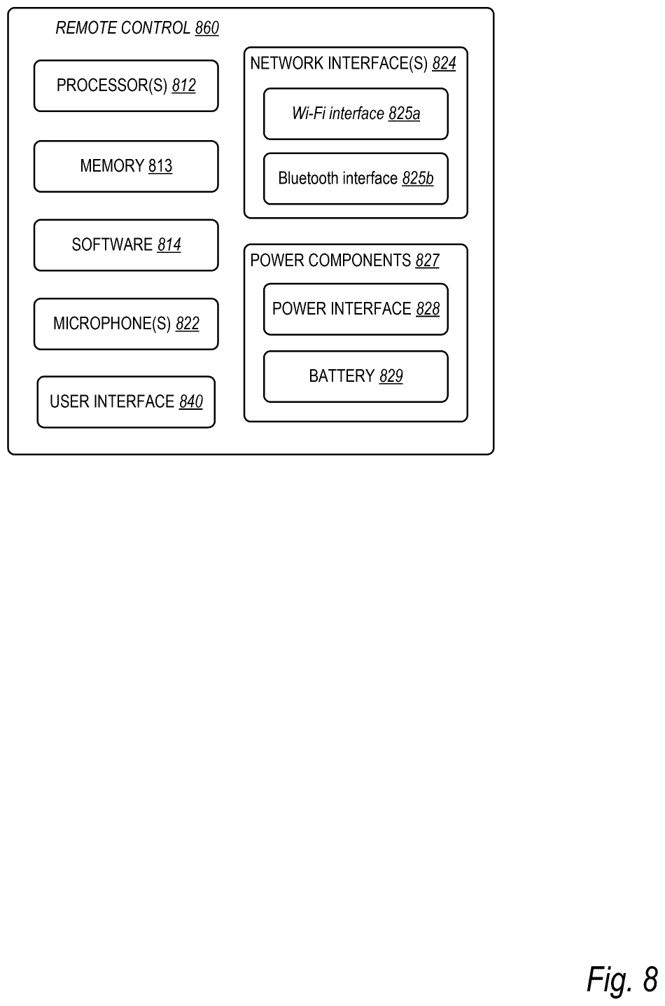

As shown in FIG. 4, the controller device 104 also includes a user interface 440 that is generally configured to facilitate user access and control of the MPS 100. The user interface 440 may include a touch-screen display or other physical interface configured to provide various graphical controller interfaces, such as the controller interfaces 540a and 540b shown in FIGS. 5A and 5B. Referring to FIGS. 5A and 5B together, the controller interfaces 540a and 540b includes a playback control region 542, a playback zone region 543, a playback status region 544, a playback queue region 546, and a sources region 548. The user interface as shown is just one example of an interface that may be provided on a network device, such as the controller device shown in FIG. 4, and accessed by users to control a media playback system, such as the MPS 100. Other user interfaces of varying formats, styles, and interactive sequences may alternatively be implemented on one or more network devices to provide comparable control access to a media playback system.

The playback control region 542 (FIG. 5A) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The playback control region 542 may also include selectable icons that, when selected, modify equalization settings and/or playback volume, among other possibilities.

The playback zone region 543 (FIG. 5B) may include representations of playback zones within the MPS 100. The playback zones regions 543 may also include a representation of zone groups, such as the Dining Room +Kitchen zone group, as shown.

In some embodiments, the graphical representations of playback zones may be selectable to bring up additional selectable icons to manage or configure the playback zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 543 (FIG. 5B) may be dynamically updated as playback zone or zone group configurations are modified.

The playback status region 544 (FIG. 5A) may include graphical representations of audio content that is presently being played, previously played, or scheduled to play next in the selected playback zone or zone group. The selected playback zone or zone group may be visually distinguished on a controller interface, such as within the playback zone region 543 and/or the playback status region 544. The graphical representations may include track title, artist name, album name, album year, track length, and/or other relevant information that may be useful for the user to know when controlling the MPS 100 via a controller interface.

The playback queue region 546 may include graphical representations of audio content in a playback queue associated with the selected playback zone or zone group. In some embodiments, each playback zone or zone group may be associated with a playback queue comprising information corresponding to zero or more audio items for playback by the playback zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 5A and 5B, the graphical representations of audio content in the playback queue region 646 (FIG. 5A) may include track titles, artist names, track lengths, and/or other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 548 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to one or both of the NMDs 102a and 102b in the Living Room shown in FIG. 1A, and a second VAS to the NMD 103f in the Kitchen. Other examples are possible.

d. Example Audio Content Sources

The audio sources in the sources region 548 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some embodiments audio content may be provided by one or more media content services.

Example audio content sources may include a memory of one or more playback devices in a media playback system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media playback system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

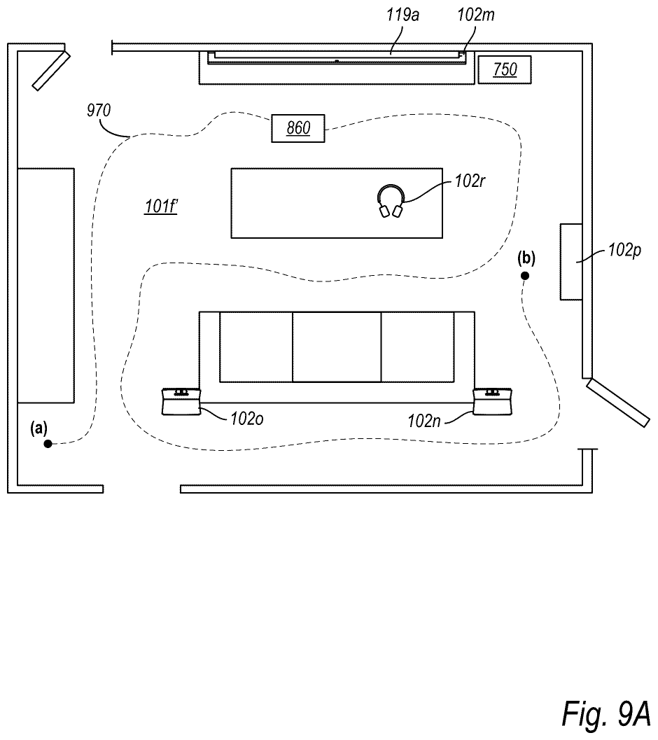

FIG. 6 is a message flow diagram illustrating data exchanges between devices of the MPS 100. At step 641a, the MPS 100 receives an indication of selected media content (e.g., one or more songs, albums, playlists, podcasts, videos, stations) via the control device 104. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 104 transmits a message 642a to the playback device 102 (FIGS. 1A-1C) to add the selected media content to a playback queue on the playback device 102.

At step 641b, the playback device 102 receives the message 642a and adds the selected media content to the playback queue for play back.

At step 641c, the control device 104 receives input corresponding to a command to play back the selected media content. In response to receiving the input corresponding to the command to play back the selected media content, the control device 104 transmits a message 642b to the playback device 102 causing the playback device 102 to play back the selected media content. In response to receiving the message 642b, the playback device 102 transmits a message 642c to the computing device 106 requesting the selected media content. The computing device 106, in response to receiving the message 642c, transmits a message 642d comprising data (e.g., audio data, video data, a URL, a URI) corresponding to the requested media content.

At step 641d, the playback device 102 receives the message 642d with the data corresponding to the requested media content and plays back the associated media content.

At step 641e, the playback device 102 optionally causes one or more other devices to play back the selected media content. In one example, the playback device 102 is one of a bonded zone of two or more players (FIG. 1M). The playback device 102 can receive the selected media content and transmit all or a portion of the media content to other devices in the bonded zone. In another example, the playback device 102 is a coordinator of a group and is configured to transmit and receive timing information from one or more other devices in the group. The other one or more devices in the group can receive the selected media content from the computing device 106, and begin playback of the selected media content in response to a message from the playback device 102 such that all of the devices in the group play back the selected media content in synchrony.

Within examples, such messages may conform to one or more protocols or interfaces (e.g., an Application Programming Interface). A platform API may support one or more namespaces that include controllable resources (e.g., the playback devices 102 and features thereof). Various functions may modify the resources and thereby control actions on the playback devices 102. For instance, HTTP request methods such as GET and POST may request and modify various resources in a namespace. Example namespaces in a platform API include playback (including controllable resources for playback), playbackMetadata (including metadata resources related to playback), volume (including resources for volume control), playlist (including resources for queue management), and groupVolume (including resources for volume control of a synchrony group), among other examples. Among other examples, such messages may conform to a standard, such as universal-plug-and-play (uPnP).

### III. Example Audio Calibration

As noted in the Overview, example technologies described herein relate to audio calibration using a remote control of a streamer device. Such technologies may utilize a multi-location acoustic calibration to characterize a listening environment. Other technologies may use a localized response to find appropriate calibration settings for the listening environment. Examples of such devices and technologies are described in the following sections.

a. Example Streamer Device and Remote Control

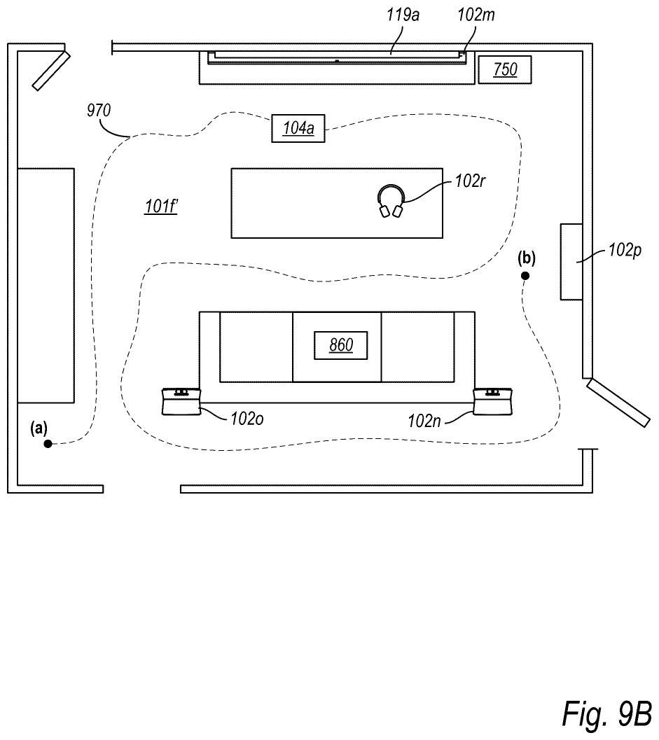

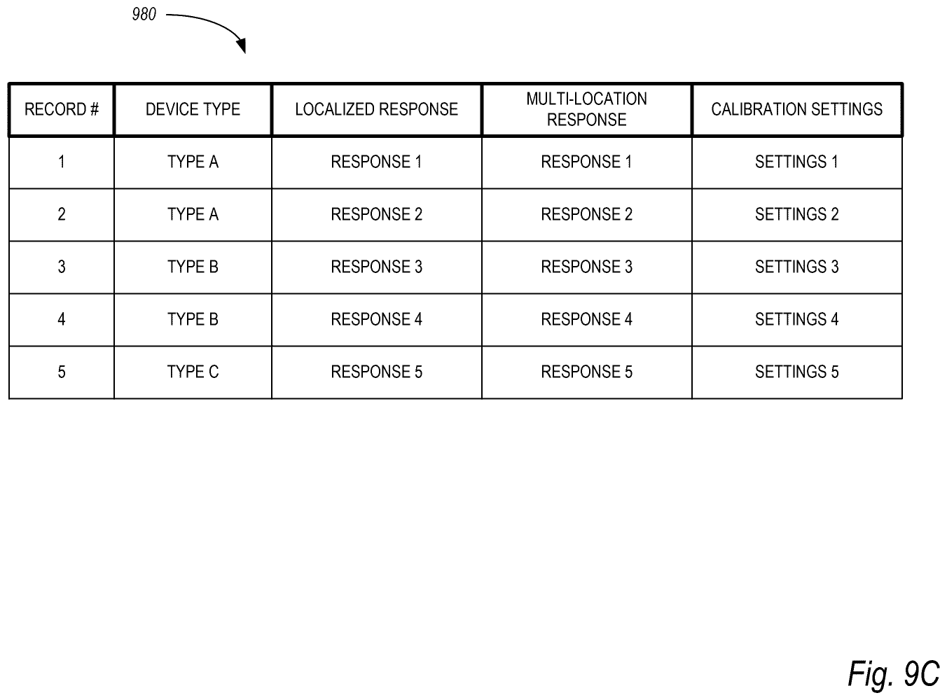

As noted above, example technologies may involve audio calibration of playback devices using a remote control of a streaming device. To illustrate such devices, FIGS. 7 and 8 are functional block diagrams illustrating certain aspects of a streamer device 750 and a remote control 860, respectively.

As shown in the functional block diagram of FIG. 7, the streamer device 750 may include some of the same or similar components as the playback device(s) 102 described in Section II in connection with FIG. 2A. For instance, the processor(s) 712 may be the same as or similar to the processor(s) 212, the memory 713 may be the same as or similar to the memory 213, and likewise for the other components shown in FIG. 7A. As another example, the power components 727 may be the same or similar to the power components 227. As such, the descriptions of these components are not repeated.

The software 714 configures the streamer device 750 for various functions consistent with a streaming set-top box or stick, such as streaming media from various sources (e.g., streaming audio/video services) and outputting A/V signals to a television or other display (e.g., one of the televisions 119 shown in FIG. 1A). Moreover, the software 714 may configure the stream to provide a graphical user interface for display on the television, which, via the remote control 860, can be navigated and used to select content. The user interface 740 of the streamer device 750 may include this graphical user interface and/or one or more physical controls (e.g., buttons) on the streamer device 750 (e.g., a power button, a reset button, transport controls, and the like).

Moreover, like the software 214, the software 714 may configure the streamer device 750 to function as a part of the media playback system 100 (FIGS. 1A and 1B). For instance, the software 714 may configure the streamer device 750 to act as a group coordinator to one or more playback devices 102. As a group coordinator, the streamer device 750 distributes audio and timing information to various playback devices 102 that are configured as group members via a network (e.g., the LAN 111 of FIG. 1B). As such, in these examples, the streamer device 750 might not send the audio portion of streamed media to a television, but instead distribute the audio to various playback devices 102 for output. To facilitate such features, the streamer device 750 may include audio processing 716, which may be the same as or similar to the audio processing 216 of the playback device 102. In such examples, the streamer device 750 might not play any audio itself, but instead perform the group coordinator of timing and audio distribution.

The streamer device 750 includes one or more network interface(s) 724, which may include a Wi-Fi interface 725a and/or a Bluetooth interface 725b. The network interface(s) 724 may also include one or more wired interfaces, such as an IEEE 802.3-compatible ethernet port. Within examples, the streamer device 750 may connect to a local area network, such as the LAN 111 (FIG. 1B) via the Wi-Fi interface 725a and/or the IEEE 802.3-compatible ethernet port. In some examples, the streamer device 750 may operate as an access point for one or more of the playback devices 102, such as when operating as a group coordinator. The streamer device 750 may connect to the remote control via the Bluetooth interface 725b.

In further examples, the speakers of a television 119 are utilized with other external playback devices 102 so as to reduce or eliminate the need for a playback device 102 to be co-located with the television (e.g., as a soundbar). For instance, the television speakers may be configured as a center channel (C) or as front channels (L/R/C) with one or more playback devices 102 providing surround audio. In such examples, a portion of the audio, such as the center channel and/or the front channels, is sent to the television for output via the television speakers with other portions, such as the front channels and/or the surround channels, being distributed by the streamer device 750 to playback devices for playback in synchrony.

In yet further examples, the streamer device 750 is integrated into a playback device 102. For instance, a playback device 102 in a soundbar form factor may integrate the streamer device 750. Soundbars are typically co-located with televisions (as illustrated by the television 119a and the playback device 102m in FIG. 1A). In such examples, as shown in FIG. 7, the streamer device 750 may include amplifiers 717 and/or audio transducers 718 to facilitate operation as a playback device 102. In such examples, the combined streamer device 750/playback device 102 may be configured as a center channel (C) or as front channels (L/R/C) with one or more playback devices 102 providing surround audio, among other possible configurations.

In some examples, the streamer device 750 is integrated into a television 119. Integration of the streamer device 750 into the television 119 may involve including additional hardware and/or software configured to provide or facilitate the streaming functions in the television 119. On the other hand, in many examples, the streamer device 750 is not integrated into a television and is instead implemented in a separate and distinct housing from the television. The housing may be formed into a box or stick, among other form factors.

Similar to FIG. 7, as shown in the functional block diagram of FIG. 8, the remote control 860 may include some of the same or similar components as the playback device(s) 102 described in Section II in connection with FIG. 2A and/or the streamer device 750 described in FIG. 7. For instance, the processor(s) 812 may be the same as or similar to the processor(s) 212, the memory 813 may be the same as or similar to the memory 213, and likewise for the other components shown in FIG. 8. As such, the descriptions of these components is not repeated.

However, given the different design considerations involved in the different types of devices, the components chosen for the streamer device 750 and/or the remote control 860 may be of different speed, capacity, or capability as compared with the components chosen for the playback devices 102. For instance, since the remote control 860 does not need to decode video or operate as a group coordinator, its processor(s) may be intentionally less capable than the processor(s) of the streamer box 750, which may reduce size, power consumption, and/or cost, among other considerations. Generally, while the different devices have similar kinds of components, the particular model of each component implemented in each device will vary based on the individual design considerations of that device.

The remote control 860 includes one or more microphones 822. The microphones 822 may be selected for consistency in their microphone response. With a known, consistent microphone response, the microphone response can be offset or otherwise accounted for during calibration so that microphone characteristics are not mistaken for environmental acoustic characteristics. Relative to other calibration procedures that involve using microphones of a mobile device for calibration, the range of microphones 822 selected for the remote control 860 may be much smaller and thus more practically accounted for during calibration. That is, since there are a wide range of mobile devices available on the market with many having different microphones, one advantage of using a remote control is that the microphone(s) used in the calibration are more reliably consistent as compared with mobile phone microphones. The microphones 822 may be multi-purpose in that they may be used for multiple types of capabilities, such as voice control and calibration.

The user interface 840 may include various controls for controlling operation of the streamer device 750. For instance, the user interface 840 may include directional controls to navigate a graphical user interface (e.g., a tiled-based UI), transport controls (e.g., play/pause/skip/etc) to control playback of media, and/or volume controls to control volume of the playback. When controls are pressed or otherwise engaged, the remote control device 860 may send data representing such commands to the streamer device 750 via the network interface(s) 924 (e. g, via the Wi-Fi interface 925a or the Bluetooth interface 925b), among other possible communication mediums (e.g., IR). In some examples, the Bluetooth interface 725b is compatible with Bluetooth Low Energy (BLE) so as to provide similar performance and range as Bluetooth albeit with relatively lower power consumption.

The remote control 860 includes power components 827, which include a power interface 828 and a battery 829. Within examples, the power interface 828 includes a direct current (DC) interface such as a USB connection (e.g., USB Type-C), which is configured to receive current to charge the battery 929. In other examples, the power components 827 include connectors for one or more replaceable batteries (e.g., AA, AAA, or other replaceable batteries).

The components of the remote control 860 may be carried in a housing. The housing may be formed or otherwise ergonomically-shaped for handheld use. For instance, the various controls of the user interface 840 of the remote control 860 may be carried on the top, sides, and/or bottom of the housing to facilitate interaction with the buttons with the fingers or thumb while the housing of the remote control 860 is being held.

b. Example Multi-location Acoustic Calibration Using a Remote Control

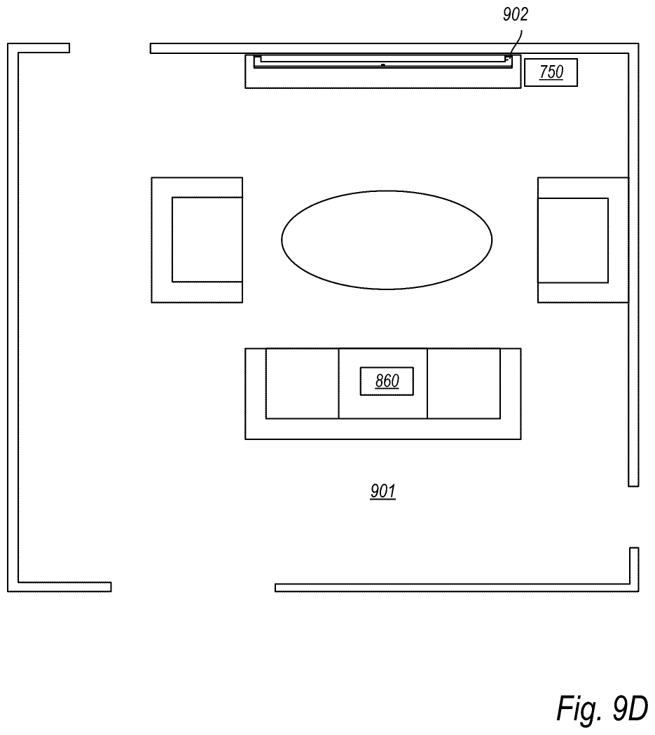

FIG. 9A depicts an example environment for performing a multi-location acoustic calibration of a playback device. In particular, FIG. 9A shows an overhead view of the living room 101f (FIG. 1A), which is provided as one illustrative example of an example environment that includes playback devices for calibration. As previously discussed, the living room 101f includes the playback device 102m, the playback device 102o, the playback device 102n, and the playback device 102p (referred to collectively as the playback devices 102m-p). While the playback devices 102m-p are shown by way of illustration, example multi-location acoustic calibrations described herein may be used to calibrate environments that include additional or fewer playback devices.

In FIG. 9A, the living room 101f is designated as the living room 101f′ so as to designate the addition of the streamer device 750 (FIG. 7) and the remote control 860 (FIG. 8) to the living room 101f, as shown. Here, the streamer device 860 is connected to the television 119a via a suitable video (or audio/video) interface, such as an HDMI interface or a wireless interface. The remote control 860 is connected to the streamer device 750 via a suitable interface (e.g., a Bluetooth connection) for remote control of the streamer device 750, as well as other operations, such as calibration.

In this example, the remote control 860 is positioned in the living room 101f′ to facilitate a multi-location acoustic calibration. In particular, during multi-location calibration, the remote control 860 captures playback by the playback devices 102m-p using one or more microphones such as the microphones 822 (FIG. 8). When the playback devices 102m-p play back calibration audio in the living room 101f′, the acoustics of the living room 101f′ affect the audio being played back. That is, the shape, size, materials, and objects within the living room reflect the played back audio in a particular manner, thus giving the living room 101f′ its acoustic characteristics. These acoustic characteristics are thus represented in the audio captured by the remote control 860 and can be used to determine an acoustic response of the living room 101f′.

Capturing playback from multiple locations within the environment may improve the representation of the acoustics within the captured audio. As such, while the playback devices 102m-p output the audio content, the remote control 860 may be moved to various locations within the living room 101f. For instance, the remote control 860 may move between a first physical location and a second physical location within the living room 101f′. As the remote control 860 is moved, its microphones record playback of the calibration audio at different locations thereby creating samples representing the acoustics of the living room 101f′ from different locations within the room.

As shown in FIG. 9A, the first physical location may be the point (a), and the second physical location may be the point (b). While moving from the first physical location (a) to the second physical location (b), the remote control 860 may traverse locations within the living room 101f′ where one or more listeners may experience audio playback during regular use of the playback devices 102m-p. For instance, as shown, a path 970 between the first physical location (a) and the second physical location (b) covers locations where one or more listeners may experience audio playback during regular use of the playback devices 102m-p.

In some examples, movement of the remote control 860 between the first physical location (a) and the second physical location (b) is performed by a user. The user may also move the remote control 860 vertically (e.g., by alternating moving the hand that is holding the control device 104a upwards and downwards) to capture the environment from different heights while traversing the path 970. Such horizontal and/or vertical movement of the remote control 860 during the calibration may be referred to as a “room dance. ” U.S. Pat. No. 9,706,323 entitled, “Playback Device Calibration,” which was previously incorporated by reference in its entirety, provides examples of calibration using such movement.

Example multi-location calibration procedures may also include measurements from a preferred listening location, such as a set on the couch shown in the living room 101f. During example calibrations, the control device 104a captures audio from the playback devices 102m-p from the preferred listening location, which can be used to offset differences in relative positioning of the playback devices 102m-p to the preferred listening locations, such as time-of-flight and phase, among others. U.S. Pat. No. 9,860,670 entitled, “Playback Device Calibration,” which is hereby incorporated by reference in its entirety, provides examples of calibration using spatial and spectral components.

Some example calibrations procedures involve adjusting the audio rendering timing to account for rendering latency and sound propagation time. That is, video processing, rendering, and travel to the user is relatively instantaneous compared to audio so the audio path will have some inherent rendering and travel latency (i.e., between playback devices 102 and from transducer to ear). By measuring audio delays from the playback devices 102m-p (and possibly individual transducers of each playback device 102), these delays can be offset by timing delays included in a calibration to have sound from each speaker arrive at a preferred listening location simultaneously. Further, different delays may be applied to each playback device 102 (or each transducer therein) so as to “steer” the audio, which can be used for instance to create a wider surround stage or stereo effect, among other applications. Examples of such calibrations are described in PCT App. No. PCT/2024/021671 entitled, “Content-Aware Multi-Channel Multi-Device Time Alignment,” which is hereby incorporated by reference in its entirety.

Yet further, some example calibration procedures involve determining different calibrations for different types of audio. For instance, different calibrations may be used with audio-only content as compared with audio that is accompanying video as such audio needs to be played back substantially at the same time as the video for lip synchronization. Examples of different calibrations for different types of audio are described in PCT App. No. PCT/2024/021671, which was previously incorporated by reference in its entirety.

In some examples, the streamer device 750 outputs a guide, such as a video or a series of images, that prompt a user through the multi-location calibration. For instance, the streamer device 750 may cause the television 119a to display such a guide, possibly with accompanying audio being output via the playback devices 102m-p and/or the television speakers. This guide may include prompts to move the remote control 860 according to the room dance, among other movements, such as positioning the remote control 860 in a preferred listening location.

For instance, such a guide may include an indication to move the remote control 860 within the living room 101f′. For instance, the graphical display may display text, such as “While audio is playing, please move the remote control through locations within the room where you or others may enjoy music. ” Other examples are also possible; for instance, the graphical display may also prompt the user to move their hand upwards and downwards during the room dance or prompt the user to sit at a preferred listening location for some samples to be captured at that location.

In other examples, the control device 104a outputs the guide. U.S. Pat. No. 9,690,539 entitled, “Speaker Calibration User Interface,” which is hereby incorporated by reference in its entirety, provides examples of a computing device that provides prompts (e.g., a guide) to facilitate aspects of a multi-location calibration.

As part of the calibration, the remote control 860 may perform a movement validation to determine whether the remote control 860 was moved sufficiently during the calibration to capture samples from different parts of the environment. Such movement validation may include measuring times-of-flight from the one or more playback devices 102m-p to the remote control 860 and determine whether differences in measured times-of-flight represent motion that does not meet a motion threshold for calibration. If the threshold is not met, the streamer device 750 and/or the remote control 860 may output a notification or a prompt to repeat all or part of the room dance. U.S. Pat. No. 9,693,165 entitled, “Validation of Audio Calibration Using Multi-Dimensional Motion Check,” which is hereby incorporated by reference in its entirety, provides examples of movement validation during a multi-location calibration.

As noted above, during calibration, the playback devices 102m-p output calibration audio for the control device 104a to capture via its microphones. In one example, the calibration audio is a test signal or a measurement signal that is representative of audio content that might be played by the playback devices 102m-p during regular use by a user. Accordingly, the calibration audio may include content with frequencies substantially covering a renderable frequency range of the playback devices 102m-p or a frequency range audible to a human. Some examples use an audio signal designed specifically for use when calibrating playback devices such as the playback devices 102m-p being calibrated in examples discussed herein. In other examples, the audio content is an audio track that is a favorite of a user of the MPS 100, or a commonly played audio track by the playback devices 102m-p. Other examples are also possible.

Examples of an audio signal designed specifically for use when calibrating playback devices such as the playback devices 102m-p include a hybrid test tone that includes two components, such as a noise portion at low frequencies in a calibration frequency range and a swept component that sweeps through higher frequencies of the calibration frequency range. U.S. Pat. No. 9,736,584 entitled, “Hybrid Test Tone for Space-Averaged Room Audio Calibration Using A Moving Microphone,” which is hereby incorporated by reference in its entirety, provides examples of hybrid test tones.

Within examples, the playback devices 102m-p (and their respective channels and/or transducers) may stagger their respective output during calibration so that individual output from each device, channel, or transducer can be captured by the microphones 822. That is, individual transducers, channels formed by contributions from two or more transducers, or the playback device 102 as a whole may be individually calibrated during the multi-location calibration. U.S. Pat. No. 10,127,006 entitled, “Facilitating Calibration of an Audio Playback Device,” which is hereby incorporated by reference in its entirety, provides examples of concurrent calibration of multiple sound sources.

After capturing the calibration audio, a multi-location acoustic response of the living room 101f′ is determined. In some examples, the captured calibration audio is streamed or otherwise transmitted from the remote control 860 to the streamer device 750, which determines the multi-location acoustic response. In further examples, the captured calibration audio is transmitted to a network-connected device, such as one of the playback devices 102 (FIG. 1A) or one of the computing devices 106 (FIG. 1B), which determines the multi-location acoustic response. In yet further examples, the multi-location acoustic response is determined by the remote control 860. Other examples involve multiple devices determining the multi-location acoustic response.

As noted above, in some examples, the captured calibration audio is streamed or otherwise transmitted from the remote control 860 for processing. In some examples, the signal path of the calibration audio from capture to transmission has a relatively lower dynamic range as compared with capture by a mobile phone. This lower dynamic range may result from the components used. For instance, an example remote control 860 may include a Bluetooth integrated circuit (IC) that includes an integrated microphone input, which may save cost or power, among other possible benefits. However, a signal path using such an IC may have a lower dynamic range (e.g., 78 dB) relative to discrete components for capture and Bluetooth (e.g., 100 dB) as may be found in a mobile phone with a microphone. To account for such differences, the playback devices 102m-p may be configured with certain gains on the calibration audio to keep the output within the dynamic range of the remote control 860.

Also as noted above, the microphones 822 may be used for multiple purposes, such as voice control and calibration, which may create design conflicts. For instance, to support voice control, the remote control 860 may encode audio captured via the microphones 822 using a perceptual codec, such as ADPCM or Opus, among other examples. Such codecs may be unsuitable for calibration because of the lossy manner in which they encode audio. Moreover, such audio may be stored in a memory with a limited storage capacity suitable for voice recordings (e.g., <10 seconds of audio) and not suitable for calibration (e.g., >30 seconds of audio). Yet further, voice control may involve push-to-talk activation in which selection of a voice control button activates, powers on, or otherwise enables the microphones 822. Requiring a push-to-talk button to be pressed for the entirety of a calibration audio measurement may harm the user experience.

In some examples, to avoid such issues, the remote control 860 may handle audio capture during calibration differently from audio captured during other uses, such as voice control. For instance, to avoid codec or memory issues, the remote control 860 may directly stream raw (e.g., uncompressed or unencoded) audio to the streamer device 750 for pre-processing, which may avoid use of the perceptual codecs and/or the limited memory. In other examples, the remote control 860 may switch to a different codec suitable for calibration, such as a lossless codec like PCM, and/or transmit portions of the captured in segments (so as to not exceed the limited memory). Yet further, to avoid requiring a prolonged press of a push-to-talk button for activation, the remote control 860 may bypass the push-to-talk activation and activate the microphones 822 during calibration without necessarily requiring user input.

The multi-location acoustic response is an acoustic response of the living room 101f based on the detected audio data representing reflections of the audio content at multiple locations in the living room 101f′, such as at the first physical location (a), the second physical location (b) and/or locations along the path 970. The multi-location acoustic response may be represented as a spectral response, spatial response, or temporal response, among others. The spectral response may be an indication of how volume of audio sound captured by the microphone varies with frequency within the living room 101f′.

A power spectral density is an example representation of the spectral response. The spatial response may indicate how the volume of the audio sound captured by the microphone varies with direction and/or spatial position in the living room 101f′. The temporal response may be an indication of how audio sound played by the playback devices 102m-p, e.g., an impulse sound or tone played by the playback devices 102m-p, changes within the living room 101f. The change may be characterized as a reverberation, delay, decay, or phase change of the audio sound.

The responses may be represented in various forms. For instance, the spatial response and temporal responses may be represented as room averages. Additionally, or alternatively, the multi-location acoustic response may be represented as a set of impulse responses or bi-quad filter coefficients representative of the acoustic response, among others. Values of the multi-location acoustic response may be represented in vector or matrix form.

Audio played by the playback devices 102m-p is adjusted based on the multi-location acoustic response of the living room 101f′ so as to offset or otherwise account for acoustics of the living room 101f′ indicated by the multi-location acoustic response. In particular, the multi-location acoustic response is used to identify calibration settings, which may include determining an audio processing algorithm. U.S. Pat. No. 9,706,323, incorporated by reference above, discloses various audio processing algorithms, which are contemplated herein.

In some examples, determining the calibration settings involves determining one or more audio processing algorithms that, when applied to the playback devices 102m-p, adjust audio content output by the playback devices 102m-p in the living room 101f′ to have one or more target frequency responses. For instance, determining the audio processing algorithm may involve determining frequency responses at the multiple locations traversed by the network device while moving within the living room 101f′ and determining an audio processing algorithm that adjusts the frequency response of the room as represented by the responses to more closely reflect a target frequency response. In one example, if one or more of the determined frequency responses has a particular audio frequency that is more attenuated than other frequencies, then determining the audio processing algorithm may involve determining an audio processing algorithm that increases amplification at the particular audio frequency. Other examples are possible as well. In some examples, the audio processing algorithm takes the form of a filter or equalization.

Since the playback devices 102 are in communication with one another and the other devices during playback, the calibration settings may be applied in different ways. For example, the calibration settings may be applied by the playback devices 102m-p (e.g., via audio processing components 112g). Alternatively, the calibration settings may be applied by another playback device 102, the streamer device 750, the computing devices 106 (FIG. 1A), and/or the control device 104a, which then provides the processed audio content to the playback devices 102m-p for output. The calibration settings may be applied to audio content played by the playback devices 102m-p until such time that the filter or equalization is changed or is no longer valid for the living room 101f′.

c. Example Local Acoustic Calibration Using a Remote Control

In further examples, a multi-location acoustic response might not be practical or convenient, among other considerations. In such examples, the media playback system 100 may perform a calibration that utilizes a dataset of (i) previously captured responses in various environments and (ii) appropriate calibration settings for that environment. Given the availability of this dataset, the remote control 860 does not necessarily need to capture a full representation of the acoustic characteristics of the environment but can instead capture a representative sample referred to as a localized acoustic response. This calibration may be referred to as a local calibration, as the localized acoustic response can be captured from a single location or from a relatively smaller set of locations and/or positions as compared with the multi-location calibration described above.

The local calibration may also be useful in situations where the microphones 822 are not capable of capturing all of the acoustic characteristics of an environment in the relevant frequency range because of limited sensitivity. Within examples, the microphones 822 of the remote control 860 might not be sensitive to frequencies, such as low frequencies, that are within the operational range of the playback devices 102m-p. For instance, the microphones 822 may have a low frequency corner at 85 Hz such that lower frequencies are not able to be captured when output by the playback devices 102m-p. As such, acoustic characteristics within such ranges are not represented in the captured audio. Using the local calibration, the remote control 860 may capture audio across a smaller range or dataset, but use this representative portion to identify a room response with a larger range that is similar.

Within examples, the dataset may be maintained and stored remotely from the media playback system 100, such as on the computing devices 106c (FIG. 1B). Recall that the computing devices 106 represent servers located remotely from the room MPS 100 and connected to the playback device(s) 102, the control device(s) 104, and/or the streamer device 750 over a wired or wireless communication network. This arrangement allows the media playback system 100 to access a larger dataset than could practically be stored locally and also for additional data to be more practically added to the dataset over time. During a local calibration, the media playback system 100 (e.g., via the streamer device 750) may query the dataset with the representative sample.

The multi-location calibration described above may be used to build and/or enhance the dataset. For instance, as illustrated in FIG. 9B, while a device with a suitable microphone, such as the control device 104a, captures calibration audio during a multi-location calibration, the remote control 860 concurrently captures audio data at a stationary location for determining a localized acoustic response. The localized acoustic response is an acoustic response of the living room 101f′ based on the detected audio data representing reflections of the audio content at a stationary location in the room. The stationary location may be at a preferred listening location but may also be at one or more microphones located on or proximate to the playback devices 102m-p.

The localized acoustic response may be represented as a spectral response, spatial response, or temporal response, among others. The spectral response may be an indication of how volume of audio sound captured by the microphone varies with frequency within the living room 101f. A power spectral density is an example representation of the spectral response. The spatial response may indicate how the volume of the audio sound captured by the microphone varies with direction and/or spatial position in the living room 101f'. The temporal response may be an indication of how audio sound played by the playback devices 102m-p (e.g., an impulse sound or tone played by the playback devices 102m-p) changes within the living room 101f′. The change may be characterized as a reverberation, delay, decay, or phase change of the audio sound.

The spatial response and temporal response may be represented as averages in some instances. Additionally, or alternatively, the localized acoustic response may be represented as a set of impulse responses or bi-quad filter coefficients representative of the acoustic response, among others. Values of the localized acoustic response may be represented in vector or matrix form.

FIG. 9C depicts a simplified representation of an example dataset 980 for storing both the determined multi-location calibration settings for the playback devices 102m-p and the localized acoustic response of the living room 101f′. Once the multi-location calibration settings for the playback devices 102m-p and the localized acoustic response of the living room 101f′ are determined, this data is then provided to a computing device, such as computing devices 106, for storage in a database. For instance, the control device 104a may send the determined multi-location calibration settings to the computing devices 106, and the streamer device 750 may send the localized acoustic response of the living room 101f′ to the computing devices 106. In other examples, one device sends both the determined multi-location calibration settings and the localized acoustic response of the living room 101f′ to the computing devices 106. Other combinations are possible as well.

The dataset 980 may be stored on a computing device, such as computing devices 106, located remotely from the playback devices 102m-p and/or from the control device 104a, or the dataset 980 may be stored on the playback devices 102m-p and/or the control device 104a. The dataset 980 includes a number of records, and each record includes data representing multi-location calibrations settings (identified as “settings 1” through “settings 5”) for various playback devices as well as localized room responses (identified as “response 1A” through “response 5A”), and multi-location acoustic responses (identified as “response 1B through “response 5B), associated with the multi-location calibration settings. For the purpose of illustration, the dataset 980 only depicts five records (numbered 1 5), but in practice should include many more than five records to improve the accuracy of the calibration processes described in further detail below.

When the computing devices 106 receives data representing the multi-location calibration settings for the playback devices 102m-p and data representing the localized acoustic response of the living room 101f, the computing devices 106 stores the received data in a record of the dataset 980. As an example, the computing devices 106 stores the received data in record #1 of the dataset 980, such that “response 1” includes data representing the localized acoustic response of the living room 101f, and “settings 1” includes data representing the multi-location calibration settings for the playback devices 102m-p. In some cases, the dataset 980 also includes data representing respective multi-location acoustic responses associated with the localized acoustic responses and the corresponding multi-location calibration settings. For instance, if record #1 of dataset 980 corresponds to playback devices 102m-p, then “response 1” may include data representing both the localized acoustic response of the living room 101f′ and the multi-location acoustic response of the living room 101f′.

As indicated above, each record of the dataset 980 corresponds to a historical playback device calibration process in which a particular playback device was calibrated by determining calibration settings based on a multi-location acoustic response, as described above in connection with FIG. 9A. The calibration processes are “historical” in the sense that they relate to multi-location calibration settings and localized acoustic responses determined for rooms with various types of acoustic characteristics previously determined and stored in the dataset 980. As additional iterations of the calibration process are performed, the resulting multi-location calibration settings and localized acoustic responses may be added to the dataset 980.

As shown in the dataset 980, the localized room response and the calibration settings based on the multi-location calibration are correlated. In operation, the remote control 750 may leverage the historical multi-location calibration settings and localized acoustic responses stored in the dataset 980 when performing a local calibration to account for the acoustic responses of the room under calibration.

Efficacy of the applied calibration settings is influenced by a degree of similarity between the identified stored acoustic response in the dataset 980 and the determined acoustic response for the playback device being calibrated. In particular, if the acoustic responses are significantly similar or identical, then the applied calibration settings are more likely to accurately offset or otherwise account for an acoustic response of the room in which the playback device being calibrated is located (e.g., by achieving or approaching a target frequency response in the room, as described above). On the other hand, if the acoustic responses are relatively dissimilar, then the applied calibration settings are less likely to accurately account for an acoustic response of the room in which the playback device being calibrated is located. Accordingly, populating the dataset 980 with records corresponding to a significantly large number of historical calibration processes may be desirable so as to increase the likelihood of the dataset 980 including acoustic response data similar to an acoustic response of the room of the playback device presently being calibrated.

As further shown, in some examples, the dataset 980 includes data identifying a type of a playback device associated with each record. Playback device “type” refers to a model and/or revision of a model, as well as different models that are designed to produce similar audio output (e.g., playback devices with similar components), among other examples. The type of the playback device may be indicated when providing the calibration settings and room response data to the dataset 980. Examples of playback device types offered by Sonos, Inc. include, by way of illustration, various models of playback devices such as a “SONOS ONE,” “PLAY: 1,” “PLAY: 3,” “PLAY: 5,” “PLAYBAR,”“PLAYBASE,”“CONNECT: AMP,”“CONNECT,”and “SUB,”among others.

In some examples, the data identifying the type of the playback device additionally or alternatively includes data identifying a configuration of the playback device. For instance, as described above in connection with FIG. 3B-3E, a playback device may be a bonded or paired playback device configured to process and reproduce sound differently than an unbonded or unpaired playback device. Accordingly, in some examples, the data identifying the type of the playback devices 102m-p includes data identifying whether the playback devices 102m-p is in a bonded or paired configuration.

By storing in the dataset 980 data identifying the type of the playback device, the dataset 980 may be more quickly searched by filtering data based on playback device type, as described in further detail below. However, in some examples, the dataset 980 does not include data identifying the device type of the playback device associated with each record.

In some implementations, calibration settings for a first type of playback device may be used for a second type of playback device, provided that a model is created to translate from the first type to the second type. The model may include a transfer function that transfers a response of a first type of playback device to a response of a second type of playback device. Such models may be determined by comparing responses of the two types of playback devices in an anechoic chamber and determining a transfer function that translates between the two responses.

FIG. 9D depicts an example in which the remote control 750 leverages the dataset 980 to perform a local calibration without determining a multi-location acoustic response of a room 901. The room 901 is representative of an environment that may include a playback device for calibration. The playback device 902 may be similar to or the same as any of the example playback devices 102a-p previously introduced.

In one example, calibration of the playback device 902 may be initiated via a controller device, such as the controller device 104a depicted in FIG. 1A. For instance, a user may access a controller interface for the playback device 902 to initiate calibration of the playback device 902. In one case, the user may access the controller interface, and select the playback device 902 (or a group of playback devices that includes the playback device 902) for calibration. In some cases, a calibration interface may be provided as part of a playback device controller interface to allow a user to initiate playback device calibration. Other examples are also possible.

Additionally, because calibration of the playback device 902 involves accessing and retrieving calibration settings from the dataset 980, as described in further detail below, initiating calibration of the playback device 902 periodically, or after a threshold amount of time has elapsed after a previous calibration, may further improve a listening experience in the room 901 by accounting for changes to the dataset 980. For instance, as users continue to calibrate various playback devices in various rooms, the dataset 980 continues to be updated with additional acoustic room responses and corresponding calibration settings. As such, a newly added acoustic response (i.e., an acoustic response that is added to the dataset 980 after the playback device 902 has already been calibrated) may more closely resemble the acoustic response of the room 901. Thus, by initiating calibration of the playback device 902 periodically, or after a threshold amount of time has elapsed after a previous calibration, the calibration settings corresponding to the newly added acoustic response may be applied to the playback device 902.

When performing the calibration process, the remote control 860 captures playback by the playback device 802 and the streamer device 750 determines a localized acoustic response of its room 901 similarly to how a localized acoustic response of the living room 101f′ was determined. Once the localized acoustic response of the room 901 is known, the playback device 902 accesses the dataset 980 to determine a set of calibration settings to account for the acoustic response of the room 901. More specifically, the playback device 902 determines a recorded and stored localized acoustic response recorded during a previous multi-location calibration which is within a threshold similarity (e.g., most similar to) the localized acoustic response of the room 901. For example, the playback device 902 establishes a connection with the computing devices 106 and with the dataset 980 of the computing devices 106, and the playback device 902 queries the dataset 980 for a stored acoustic room response that corresponds to the determined localized acoustic response of the room 901.

In some examples, querying the dataset 980 involves mapping the determined localized acoustic response of the room 901 to a particular stored acoustic room response in the dataset 980 that satisfies a threshold similarity to the localized acoustic response of the room 901. This mapping may involve comparing values of the localized acoustic response to values of the stored localized acoustic room responses and determining which of the stored localized acoustic room responses are similar to the instant localized acoustic response. For example, in implementations where the acoustic responses are represented as vectors, the mapping may involve determining distances between the localized acoustic response vector and the stored acoustic response vectors. In particular, the captured data set may be mapped to an estimated room response with a transfer function that has been derived from a dataset of previously captured room responses. U.S. Pub. No. 2023/0362590 A1 entitled, “Playback Device Self-Calibration Using PCA-Based Room Response Estimation,” which was previously incorporated by reference in its entirety, provides examples of such technologies.

In such a scenario, the stored acoustic response vector having the smallest distance from the localized acoustic response vector of the room 901 may be identified as satisfying the threshold similarity. In some examples, one or more values of the localized acoustic response of the room 901 may be averaged and compared to corresponding averaged values of the stored acoustic responses of the dataset 980. In such a scenario, the stored acoustic response having averaged values closest to the averaged values of the localized acoustic response vector of the room 901 may be identified as satisfying the threshold similarity. Other examples are possible as well.

As shown, the room 901 depicted in FIG. 9D and the living room 101f depicted in FIG. 9A are similarly shaped and have similar layouts. Further, the playback device 102m and the playback device 902 are arranged in similar positions in their respective rooms. As such, when the localized room response determined by playback device 902 for the room 901 is compared to the room responses stored in the dataset 980, the computing devices 106 may determine that the localized room response determined for the living room 101f has at least a threshold similarity to the localized room response determined by the playback device 902 for the room 901.

Once a stored acoustic room response of the dataset 980 is determined to be threshold similar to the localized acoustic response of the room 901, then the playback device 902 identifies a set of calibration settings associated with the threshold similar stored acoustic room response. For instance, as shown in FIG. 9C, each stored acoustic room response is included as part of a record that also includes a set of calibration settings designed to account for the room response. As such, the playback device 902 retrieves, or otherwise obtains from the dataset 980, the set of calibration settings that share a record with the threshold similar stored acoustic room response and applies the set of calibration settings to itself. Alternatively, the playback device 901 may determine (i.e. calculate) a set of calibration settings based on a target frequency curve and the threshold similar stored acoustic room response.

After the obtained calibration settings are applied, the playback device 902 outputs, via its one or more transducers, second audio content using the applied calibration settings. Even though the applied calibration settings were determined for a different playback device calibrated in a different room, the localized acoustic response of the room 901 is similar enough to the stored acoustic response that the second audio content is output in a manner that at least partially accounts for the acoustics of the room 901. For instance, with the applied calibration settings, the second audio content output by the playback device 902 may have a frequency response, at one or more locations in the room 901, that is closer to a target frequency response than the first audio content.

### IV. Example Calibration Methods

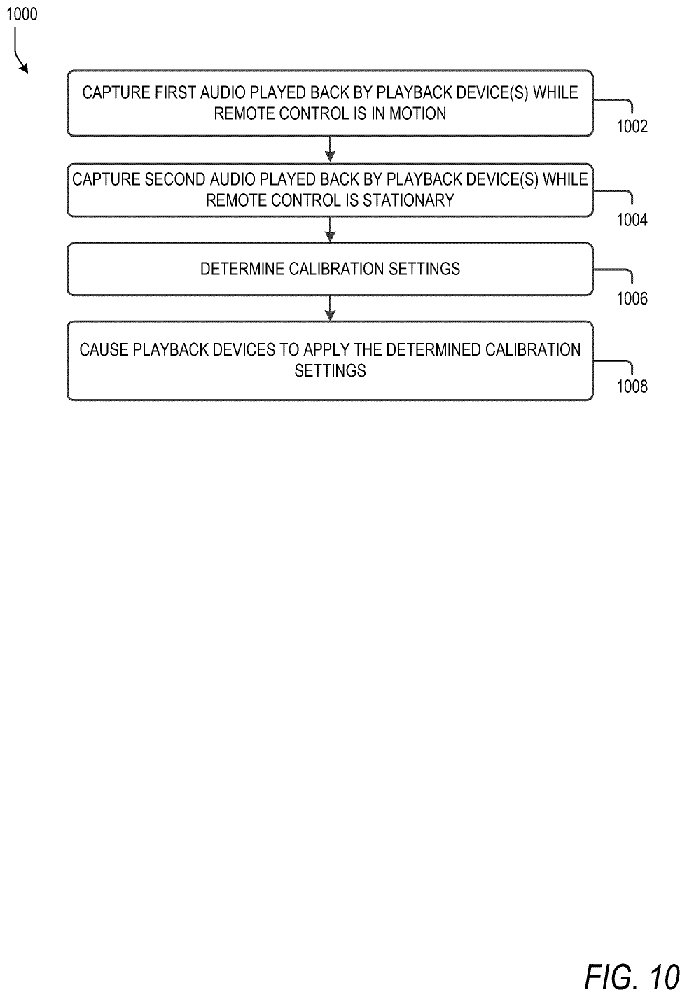

As noted previously, example technologies may involve calibration of playback devices. To illustrate, FIG. 10 is a flow diagram showing an example method 1000 for calibration. All or some of the method 1100 may be performed by a streaming device and its remote control, such as the streamer device 750 and the remote control 860 (FIGS. 7 and 8). Alternatively, all or some of the method 1000 may be performed by any suitable device or by a system of devices, such as any of the playback devices 102, NMDs 103, controller devices 104, computing devices 105, and/or computing devices 106, or a combination thereof, such as a bonded zone of playback devices 102, or a group of playback devices 102.

At block 1002, the method 1000 includes capturing, via the microphone of a remote control, first audio played back by one or more playback devices while the remote control is in motion through an environment that includes the one or more playback devices. For example, the remote control 860 (FIG. 8) may capture first audio played back by one or more of the playback devices 102m-p while in motion through the living room 101f′ (FIG. 9A), as described in connection with FIGS. 9A-9D. This capture may be performed during a first portion of a calibration.

Within examples, the remote control may receive instructions to initiate capture of the first audio. For instance, the streamer device 750 may send, via a network, such as a Bluetooth personal area network, instructions to initiate capture of the first audio via the microphone of the remote control during the first portion of the calibration. These instructions, or additional instructions, may cause the remote control 860 to temporarily enable its microphone (e.g., the microphones 822) during the calibration independently of a push-to-talk button that when pressed, enables the microphone to capture voice input to a voice assistant.

At block 1004, the method 1000 includes capturing, via the microphone of the remote control, second audio played back by one or more playback devices while the remote control is stationary in the environment at a listening location. For instance, the remote control 860 may capture second audio played back by one or more of the playback devices 102m-p while stationary in the living room 101f′ at one or more preferred listening locations, as described in connection with FIGS. 9A-9D. This capture may be performed during a second portion of a calibration.

The remote control may receive instructions to initiate capture of the second audio. For instance, the streamer device 750 may send, via a network, such as a Bluetooth personal area network, instructions to initiate capture of the second audio via the microphone of the remote control during the second portion of the calibration. These instructions, or additional instructions, may cause the remote control 860 to temporarily enable its microphone (e.g., the microphones 822) during the calibration independently of the push-to-talk button.

At block 1006, the method 1000 includes determining calibration settings. For example, the streamer device 750 (or another device that has access to the captured audio) may determine calibration settings that, when applied to playback by the one or more playback devices, at least partially offset acoustic characteristics of the environment that were represented in the captured first audio. Further, the streamer device 750 may determine the calibration settings to offset differences in relative positioning between the multiple transducers and the listening location. Examples of such calibration settings are described in connections with FIGS. 10A-10D.

At block 1008, the method 1000 includes causing, via the network interface, the one or more playback devices to apply the determined calibration settings. For instance, the streamer device 750 (or another device that determined or has access to the determined calibration settings) may send data representing the determined calibration settings to one or more of the playback devices 102m-p, which causes the playback devices to apply the determined calibration settings. In other examples, another device, such as a group coordinator, may apply the determined calibration settings to received audio and then send the processed audio to the playback devices 102m-p for output, which causes the playback devices 102m-p to play back calibrated audio.

Within examples, the method 1000 may include sending data representing at least a portion of the captured first audio and the captured second audio. For example, the remote control 860 may send, via an 802.15-compatible wireless interface (e.g., the Bluetooth interface 825b) to the streamer device 750, data representing at least a portion of the captured first audio and the captured second audio. The remote control 860 may send the data as a complete capture of the captured first audio and/or the captured second audio, in portions, or as a stream, as described in connection with FIGS. 9A-9D.

The method 1000 may further include performing a movement validation of the first portion of the calibration. Performing the movement validation may include measuring times-of-flight from the one or more playback devices 102m-p to the remote control during the first portion of the calibration and determining that differences in measured times-of-flight represent motion that does not meet a motion threshold for calibration. The method 1000 may further include outputting a prompt to repeat the first portion of the calibration based on the determination that the differences in measured times-of-flight represent motion that does not meet a motion threshold for calibration.

In some examples, the method 1000 may include updating the calibration settings based on a detect change to the acoustic characteristics of the environment. For example, the method 1000 may include capturing, via the microphone of the remote control 860, third audio played back by the one or more playback devices 102m-p and determining that the captured third audio represents at least one change to the acoustic characteristics of the environment that were represented in the captured first audio. The method 1000 may then further include updating the determined calibration settings to at least partially offset the at least one change to the acoustic characteristics of the environment that were represented in the captured third audio.

Yet further, the method 1000 may include updating the calibration settings according to a changed listening location. For instance, the method 1000 may include capturing, via the microphone of the remote control 860, third audio played back by the one or more playback devices 102m-p and determine that the captured third audio represents a change to the listening location. The method 1000 may then further include updating the determined calibration settings to offset the change to the listening location.

As another example, the method 1000 may include outputting, via a display interface connected to a display device, a video signal that causes the display device to display a graphical prompt to move the remote control through the environment during the first portion of the calibration. For instance, the streamer device 750 may output via the television 119a a video signal that cause the television 119a to display such a prompt. In further examples, the method 1000 may include causing one or more playback devices (e.g., the playback devices 102m-p) to play back an audio prompt to move the remote control 860 through the environment during the first portion of the calibration. Examples of prompts or guides to facilitate calibration are described in connection with FIGS. 9A-9D.

Yet further, the method 1000 may include outputting, via a display interface connected to a display device, a video signal that causes the display device to display a graphical prompt to display a graphical prompt to remain stationary at the listening location during the second portion of the calibration. For instance, the streamer device 750 may output via the television 119a a video signal that causes the television 119a to display such a prompt. In further examples, the method 1000 may include causing one or more playback devices (e.g., the playback devices 102m-p) to play back an audio prompt to remain stationary at the listening location during the second portion of the calibration. As noted previously, examples of prompts or guides to facilitate calibration are described in connection with FIGS. 9A-9D.

The above example features of the method 1000 are not exhaustive. The method 1000 may additionally or alternatively include features from any of the example technologies disclosed herein, as well as features of the disclosures incorporated herein by reference.

### Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

Example 1: A method comprising: during a first portion of a calibration, capturing, via a microphone of a remote control, first audio played back by one or more playback devices while the remote control is in motion through an environment that includes the one or more playback devices; during a second portion of the calibration, capturing, via the microphone of the remote control, second audio played back by the one or more playback devices while the remote control is stationary in the environment at a listening location; determining, via a streaming video set-top box, calibration settings that, when applied to playback by the one or more playback devices, at least partially (i) offset acoustic characteristics of the environment that were represented in the captured first audio and (ii) offset differences in relative positioning between the multiple transducers and the listening location; and causing, via a network interface, the one or more playback devices to apply the determined calibration settings Example 2: The method of Example 1, wherein the remote control comprises an 802.15-compatible wireless interface, wherein the method further comprises: sending, via the 802.15-compatible wireless interface to the streaming video set-top box, data representing at least a portion of the captured first audio and the captured second audio Example 3: The method of Examples 1 or 2, wherein the streaming video set-top box comprises at least one first processor and the remote control comprises at least one second processor, and wherein determining the calibration settings comprises: determining the calibration settings via the at least one first processor

Example 4: The method of Example 3, further comprising: during the first portion of the calibration, measuring times-of-flight from the one or more playback devices to the remote control; determining, via the at least one second processor, that differences in measured times-of-flight represent motion that does not meet a motion threshold for calibration; and based on the determination that the differences in measured times-of-flight represent motion that does not meet a motion threshold for calibration, outputting a prompt to repeat the first portion of the calibration.

Example 5: The method of any of Example 4, wherein measuring the times-of-flight from the one or more playback devices to the remote control comprises: measuring times-of-flights of audio played back by the one or more playback devices to the microphone of the remote control at different locations during the first portion of the calibration.

Example 6: The method of any of Examples 1-5, wherein the method further comprises: after applying the calibration settings, capturing, via the microphone of the remote control, third audio played back by the one or more playback devices; determining that the captured third audio represents at least one change to the acoustic characteristics of the environment that were represented in the captured first audio; and updating the determined calibration settings to at least partially offset the at least one change to the acoustic characteristics of the environment that were represented in the captured third audio.

Example 7: The method of any of Examples 1-6, wherein the method further comprises: after applying the calibration settings, capturing, via the microphone of the remote control, third audio played back by the one or more playback devices; determining that the captured third audio represents a change to the listening location; and updating the determined calibration settings to offset the change to the listening location

Example 8: The method of any of Examples 1-7, wherein the method further comprises: outputting, via a display interface connected to a display device, a video signal that causes the display device to display a graphical prompt to move the remote control through the environment during the first portion of the calibration.

Example 9: The method of any of Examples 1-8, wherein the method further comprises: causing the one or more playback devices to play back an audio prompt to move the remote control through the environment during the first portion of the calibration.

Example 10: The method of any of Examples 1-9, wherein the method further comprises: outputting, via a display interface connected to a display device, a video signal that causes the display device to display a graphical prompt to display a graphical prompt to remain stationary at the listening location during the second portion of the calibration.

Example 11: The method of any of Examples 1-10, wherein the method further comprises: causing the one or more playback devices to play back an audio prompt to remain stationary at the listening location during the second portion of the calibration.

Example 12: The method of any of Examples 1-11, wherein the remote control comprises a push-to-talk button that when pressed, enables the microphone to capture voice input to a voice assistant, and wherein the method further comprises: temporarily enable the microphone during the calibration independently of the push-to-talk button.

Example 13: The method of any of Examples 1-12, wherein the method further comprises: sending, from the streaming set-top box to the remote control, instructions to (i) initiate capture of the first audio via the microphone of the remote control during the first portion of the calibration and (ii) initiate capture of the second audio via the microphone of the remote control during the second portion of the calibration

Example 14: A tangible, non-transitory, computer-readable medium having instructions stored thereon that are executable by one or more processors to cause a system comprising a streamer device and a remote control to perform the method of any one of Examples 1-13.

Example 15: A system comprising a streamer device and a remote control, the system configured to perform the method of any one of Examples 1-13.

Example 16: A streamer device comprising one or more processors and a data storage having instructions stored thereon that are executable by the one or more processors to cause the streamer device to perform the method of any of Examples 1-13.

Example 17: A remote control comprising one or more processors and a data storage having instructions stored thereon that are executable by the one or more processors to cause the streamer device to perform the method of any of Examples 1-13.

We claim:

1. A system comprising:
a streaming video set-top box;
a remote control configured to control the streaming video set-top box, the remote control comprising a microphone and a wireless communications interface;
a network interface;
one or more processors; and
at least one non-transitory computer-readable medium comprising program instructions that are executable by the one or more processors such that the system is configured to:
during a first portion of a calibration, capture, via the microphone of the remote control, first audio played back by one or more playback devices while the remote control is in motion through an environment that includes the one or more playback devices;
during a second portion of the calibration, capture, via the microphone of the remote control, second audio played back by the one or more playback devices while the remote control is stationary in the environment at a listening location;
determine calibration settings that, when applied to playback by the one or more playback devices, at least partially (i) offset acoustic characteristics of the environment that were represented in the captured first audio and (ii) offset differences in relative positioning between the multiple transducers and the listening location; and
cause, via the network interface, the one or more playback devices to apply the determined calibration settings.

2. The system of claim 1, wherein the remote control comprises an 802.15-compatible wireless interface, wherein the at least one non-transitory computer readable medium further comprises program instructions that are executable by the one or more processors such that the system is configured to:
send, via the 802.15-compatible wireless interface to the streaming video set-top box, data representing at least a portion of the captured first audio and the captured second audio.

3. The system of claim 1, wherein the streaming video set-top box comprises at least one first processor of the one or more processors and the remote control comprises at least one second processor of the one or more processors, and wherein the program instructions that are executable by the one or more processors such that the system is configured to determine the calibration settings comprise program instructions that are executable by the at least one processor such that the system is configured to:
determine the calibration settings via the at least one first processor.

4. The system of claim 3, wherein the at least one non-transitory computer readable medium further comprises program instructions that are executable by the one or more processors such that the system is configured to:
during the first portion of the calibration, measure times-of-flight from the one or more playback devices to the remote control;
determine, via the at least one second processor, that differences in measured times-of-flight represent motion that does not meet a motion threshold for calibration; and
based on the determination that the differences in measured times-of-flight represent motion that does not meet a motion threshold for calibration, output a prompt to repeat the first portion of the calibration.

5. The system of claim 4, wherein the program instructions that are executable by the one or more processors such that the system is configured to measure the times-of-flight from the one or more playback devices to the remote control comprise program instructions that are executable by the at least one processor such that the system is configured to:
measure times-of-flights of audio played back by the one or more playback devices to the microphone of the remote control at different locations during the first portion of the calibration.

6. The system of claim 1, wherein the at least one non-transitory computer readable medium further comprises program instructions that are executable by the one or more processors such that the system is configured to:
after application of the calibration settings, capture, via the microphone of the remote control, third audio played back by the one or more playback devices;
determine that the captured third audio represents at least one change to the acoustic characteristics of the environment that were represented in the captured first audio; and
update the determined calibration settings to at least partially offset the at least one change to the acoustic characteristics of the environment that were represented in the captured third audio.

7. The system of claim 1, wherein the at least one non-transitory computer readable medium further comprises program instructions that are executable by the one or more processors such that the system is configured to:
after application of the calibration settings, capture, via the microphone of the remote control, third audio played back by the one or more playback devices;
determine that the captured third audio represents a change to the listening location; and
update the determined calibration settings to offset the change to the listening location.

8. The system of claim 1, wherein the at least one non-transitory computer readable medium further comprises program instructions that are executable by the one or more processors such that the system is configured to:
output, via a display interface connected to a display device, a video signal that causes the display device to display a graphical prompt to move the remote control through the environment during the first portion of the calibration.

9. The system of claim 1, wherein the at least one non-transitory computer readable medium further comprises program instructions that are executable by the one or more processors such that the system is configured to:
cause the one or more playback devices to play back an audio prompt to move the remote control through the environment during the first portion of the calibration.

10. The system of claim 1, wherein the at least one non-transitory computer readable medium further comprises program instructions that are executable by the one or more processors such that the system is configured to:
output, via a display interface connected to a display device, a video signal that causes the display device to display a graphical prompt to display a graphical prompt to remain stationary at the listening location during the second portion of the calibration.

11. The system of claim 1, wherein the at least one non-transitory computer readable medium further comprises program instructions that are executable by the one or more processors such that the system is configured to:
cause the one or more playback devices to play back an audio prompt to remain stationary at the listening location during the second portion of the calibration.

12. The system of claim 1, wherein the remote control comprises a push-to-talk button that when pressed, enables the microphone to capture voice input to a voice assistant, and wherein the at least one non-transitory computer readable medium further comprises program instructions that are executable by the one or more processors such that the system is configured to:
temporarily enable the microphone during the calibration independently of the push-to-talk button.

13. The system of claim 1, wherein the at least one non-transitory computer readable medium further comprises program instructions that are executable by the one or more processors such that the system is configured to:
send, from the streaming set-top box to the remote control, instructions to (i) initiate capture of the first audio via the microphone of the remote control during the first portion of the calibration and (ii) initiate capture of the second audio via the microphone of the remote control during the second portion of the calibration.

14. A streaming video set-top box comprising:
a network interface;
an 802.15-compatible wireless interface
one or more processors; and
at least one non-transitory computer-readable medium comprising program instructions that are executable by the one or more processors such that the streaming video set-top box is configured to:
during a first portion of a calibration, cause a remote control to capture, via a microphone of the remote control, first audio played back by one or more playback devices while the remote control is in motion through an environment that includes the one or more playback devices;
during a second portion of the calibration, cause the remote control to capture, via the microphone of the remote control, second audio played back by the one or more playback devices while the remote control is stationary in the environment at a listening location;
receive, via the 802.15-compatible wireless interface from the remote control, data representing at least a portion of the captured first audio and the captured second audio;
determine calibration settings that, when applied to playback by the one or more playback devices, at least partially (i) offset acoustic characteristics of the environment that were represented in the captured first audio and (ii) offset differences in relative positioning between the multiple transducers and the listening location; and
cause, via the network interface, the one or more playback devices to apply the determined calibration settings.

15. The streaming video set-top box of claim 14, wherein the at least one non-transitory computer readable medium further comprises program instructions that are executable by the one or more processors such that the streaming video set-top box is configured to:
measure times-of-flight from the one or more playback devices to the remote control during the first portion of the calibration;
determine that differences in measured times-of-flight represent motion that does not meet a motion threshold for calibration; and
based on the determination that the differences in measured times-of-flight represent motion that does not meet a motion threshold for calibration, output a prompt to repeat the first portion of the calibration.

16. The streaming video set-top box of claim 14, wherein the at least one non-transitory computer readable medium further comprises program instructions that are executable by the one or more processors such that the streaming video set-top box is configured to:
after application of the calibration settings, cause the remote control to capture, via the microphone of the remote control, third audio played back by the one or more playback devices;
determine that the captured third audio represents at least one change to the acoustic characteristics of the environment that were represented in the captured first audio; and
update the determined calibration settings to at least partially offset the at least one change to the acoustic characteristics of the environment that were represented in the captured third audio.

17. The streaming video set-top box of claim 14, wherein the at least one non-transitory computer readable medium further comprises program instructions that are executable by the one or more processors such that the streaming video set-top box is configured to:
after application of the calibration settings, cause the remote control to capture, via the microphone of the remote control, third audio played back by the one or more playback devices;
determine that the captured third audio represents a change to the listening location; and
update the determined calibration settings to offset the change to the listening location.

18. The streaming video set-top box of claim 14, wherein the at least one non-transitory computer readable medium further comprises program instructions that are executable by the one or more processors such that the streaming video set-top box is configured to:
output, via a display interface connected to a display device, a first video signal that causes the display device to display a graphical prompt to move the remote control through the environment during the first portion of the calibration; and
output, via the display interface connected to the display device, a second video signal that causes the display device to display a graphical prompt to display a graphical prompt to remain stationary at the listening location during the second portion of the calibration.

19. The streaming video set-top box of claim 14, wherein the remote control comprises a push-to-talk button that when pressed, enables the microphone to capture voice input to a voice assistant, and wherein the at least one non-transitory computer readable medium further comprises program instructions that are executable by the one or more processors such that the streaming video set-top box is configured to:
temporarily enable the microphone during the calibration independently of the push-to-talk button.

20. At least one non-transitory computer-readable medium comprising program instructions that are executable by one or more processors such that a system is configured to:
during a first portion of a calibration, capture, via a microphone of a remote control, first audio played back by one or more playback devices while the remote control is in motion through an environment that includes the one or more playback devices;
during a second portion of the calibration, capture, via the microphone of the remote control, second audio played back by the one or more playback devices while the remote control is stationary in the environment at a listening location;
determine, via a streaming video set-top box, calibration settings that, when applied to playback by the one or more playback devices, at least partially (i) offset acoustic characteristics of the environment that were represented in the captured first audio and (ii) offset differences in relative positioning between the multiple transducers and the listening location; and
cause, via the network interface, the one or more playback devices to apply the determined calibration settings.
